(19) United States
(12) Patent Application Publication
(10) Pub. No.: US 2003/0000870 A1
(43) Pub. Date: Jan. 2, 2003

(54) Screening device and rotor for use in a screening device

(76) Inventor: Tomas Wikstrom, Sundsvall (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/182,487

(22) PCT Filed: Jan. 15, 2001
(86) PCT No.: PCT/SE01/00058

(30) Foreign Application Priority Data
Feb. 8, 2000 (SE) 0000414-3

(51) Int. Cl. B07B 1/20

(52) U.S. Cl. 209/306; 209/273; 209/385; 210/415; 210/396

(57) ABSTRACT

Apparatus for the screening of fiber suspensions is disclosed including a housing, a reject outlet and an accept outlet, a screen located within the housing, a rotor including pulsation wings mounted therein, a reject chamber in the housing for collecting a reject portion of the fiber suspension, and an accept chamber for collecting the accept portion of the fiber suspension passing through the screen and supplying it to the accept outlet, each of the pulsation wings including an outside face and an inside face, a leading edge, a trailing edge, and upper and lower ends so that a predetermined pressure difference is created between the outside and inside faces of the pulsation wings in the direction of the lower edge thereof.

This invention relates to a device for screening fiber suspensions, such as pulp, for dividing the fiber suspension into different length fractions or separating impurities and other fractions of the pulp undesired for the final product, such as coarse particles, undefibered material and poorly worked fibers.

It is known that variations in the concentration of the pulp are of decisive importance for the screening process. A decrease in concentration implies an increase of the hydraulic load on the screening means, i.e. the flow rate through the openings in the screening means increases. At concentrations below about 0.5% the total capacity becomes unacceptably low. An increase in the concentration implies instead an increase of the energy intensity required for breaking up the fiber network into individual fibers and make it fluid, so-called fluidization, which is a prerequisite for the screening process. The concentration, thus, defines a limit for an effective utilization of the screen. Too high a concentration results in that the flocks of the fiber suspension are not broken up, which implies that the screening process cannot continue.

At a conventional pressurized screen for pulp, the thickening along the length of the screening zone, from the inlet for unscreened pulp to the outlet, the reject chamber, for discharging concentrated impurities, is the physical problem, which limits the efficiency of the screen, with regard both to capacity and efficiency. The thickening means physically that the concentration of the fiber suspension increases from the inlet to the reject outlet along the surface of the screening means. Impurities are also concentrated from the inlet to the reject outlet. Increased concentration implies, that the strength of the fiber network increases considerably.

As the rotating means of the screen rotate at equal speed along the entire length of the screening zone, the energy supply is substantially constant from the inject end to the reject end of the screening means. This implies that the screening must start at too low concentration at the beginning of the screening zone, in order to prevent that the pulp concentration rapidly becomes so high that a large portion of the screening zone acts as a thickener. Too high an energy intensity in relation to the pulp concentration implies, that the fiber suspension at the beginning of the screening zone has an unnecessarily high turbulence level, and thereby has a deteriorated separation selectivity. After a short zone with ideal conditions the pulp concentration is too high, the energy is not any longer sufficient to break up the fiber network, and the final portion of the screening zone acts as a thickener. A high degree of thickening can also give rise to a braking effect, due to mechanically transferred force between the screening means and rotating means. In other words, the thickening implies that the screen looses both efficiency and capacity.

One has succeeded in increasing the pulp concentration in certain modern pulp screens by placing inside the screening means a rotating means with pulsation creating wings, which yield an extended suction pulse, which creates a vacuum on the outside of the pulsation wing, i.e. adjacent the screen means, in order to recover through the screening means a certain amount of the liquid lost by the thickening end in order to keep the screening means open. At the same time an overpresssure is created on the inside of the pulsation wing. The difference in pressure between the inside and outside of the pulsation wing results in, that at the rear edge of the wing, seen in rotation direction, a flow of pulp from the inside of the pulsation wing to its outside is obtained. Extended suction pulses through wide pulsation wings make it possible to increase the concentration in a screen, due to the fact that more liquid can be recovered. The screening means, however, is then subjected to very high loads. Problems can also arise with erosion on the pulsation wings. The stresses become especially high in the final portion of the screening zone, because the concentration of the pulp there is the greatest, and the pulp contains there a great amount of impurities. Variations in the pulp concentration, dewatering properties or fiber length distribution affect the critical balance between network strength and energy supply. This results in that one is forced to operate the screen with higher than optimum speed in order to manage the operability even at normal process variations.

The object of the invention is a screening device where the aforesaid problems can be reduced considerably in that the pressure difference between the inside and outside of the pulsation wing is reduced at the end of the screening zone. This can suitably be achieved in that the pulsation wing at the end of the screening zone, i.e. in its lower portion, is formed in such a way that its extension in tangential direction substantially decreases gradually in the direction to the reject outlet, and where this decrease is made at the rear edge of the pulsation wing.

At a pulsation wing of conventional kind, where the pressure difference between the inside and outside is great even at the lower portion of the pulsation wing, a flow of pulp from the reject chamber to the outside of the pulsation wing is obtained. This is due to the fact that the edge of the pulsation wing toward the reject chamber, the lower edge, at rotation moves against a relatively standing still suspension in the reject chamber. This means physically that a flow from the reject chamber is more favourable than that pulp flows over the lower edge of the pulsation wing from its inside to its outside or through the screening means to the outside of the pulsation wing. The flow of pulp from the reject chamber to the screening zone, of course, contributes to a considerably deteriorated efficiency and capacity of the screening device, because this contributes strongly to a higher pulp concentration in the lower portion of the screening zone. The flow of pulp from the reject chamber to the screening zone counteracts also the downfeed of reject along the screening means to the reject chamber.

With a pulsation wing formed according to the invention a substantially reduced flow of pulp from the reject chamber to the screening zone is obtained, compared to a conventional screening device.

The invention also relates to a rotor for use in a screening device of the aforesaid kind.

The characterizing features of the invention are apparent from the attached claims.

The invention is described in greater details in the following with reference to the accompanying drawings illustrating an embodiment of the invention.

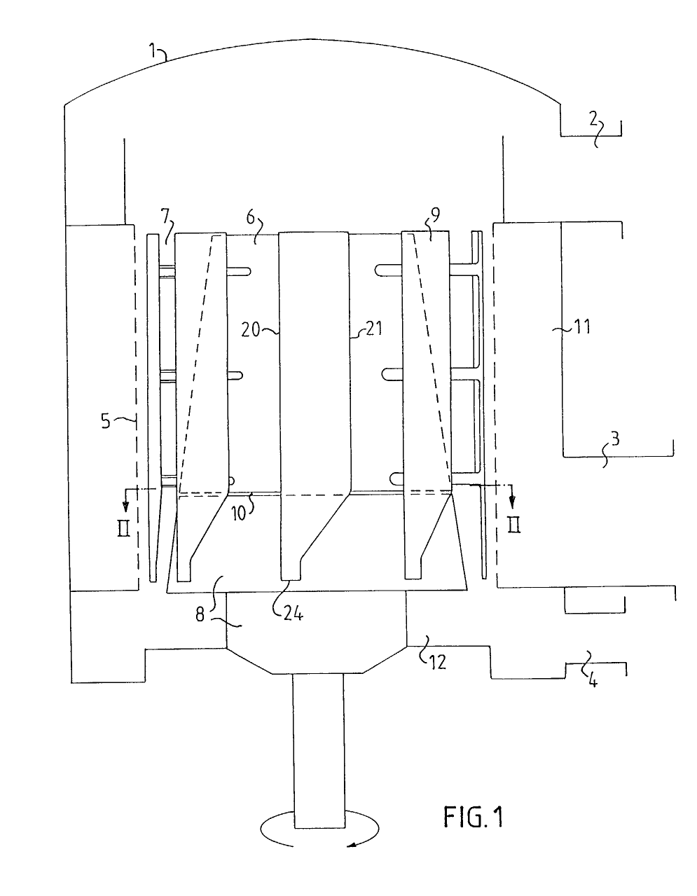

FIG. 1 shows schematically a screening device according to the invention,

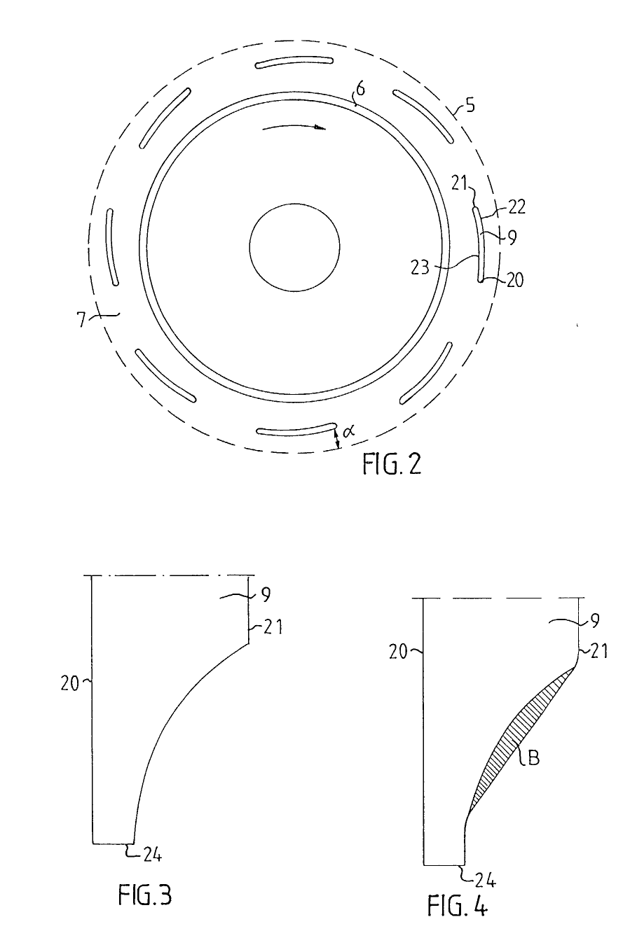

FIG. 2 is a cross-section according to II-II in FIG. 1,

FIG. 3 shows an embodiment of the pulsation wing,

FIG. 4 shows a comparison between two embodiments of the pulsation wings.

The screening device shown comprises a pressurized housing 1 with inlet 2 for pulp (inject) and outlets 3 and, respectively, 4 for accept and, respectively, reject. In the housing 1 a rotation-symmetrical screening means 5 is located stationary, preferably with vertical symmetry axis. In the screening means 5 a rotary rotor 6 is located. The rotor 6 is concentric with the screening means 5 and formed as a truncated cone, but can also be formed as a cylinder. The rotor 6 is at one end located adjacent a stationary dilution chamber 8. An overall screening zone 7 is formed between the screening means 5 and rotor 6 and, respectively, dilution chamber 8, i.e. along the entire screening means 5. Between the dilution chamber 8 and rotor 6 a dilution gap 10 allows the supply of dilution liquid to the screening zone 7.

The inject inlet 2 for the pulp is connected to the housing 1 for the supply of pulp to the upper end of the screening zone 7. The pulp flows thereafter down through the screening zone 7, and the accept fraction flows through the screening means 5 and via an accept chamber 11 located outside the screening means 5 out through the accept outlet 3. The reject fraction flows at the end of the screening zone 7 out into a reject chamber 12 located outside the lower portion of the dilution chamber 8 and out through the reject outlet 4.

The rotor 6 is on its outside provided with pulsation wings 9 distributed in the circumferential direction. The wings 9 extend axially along the entire screening zone 7 and have a lower edge 24 toward the reject chamber 12. These wings 9 are placed at a distance from the rotor 6 and are formed with a leading edge 20 located near the screening means 5 and a rear edge 21 located at a greater distance from the screening means 5. The wings 9 produce thereby a suction pulse when they move along the screening means 5, which pulse keeps the screening means 5 open and promotes the separation of the accept.

Every pulsation wing 9 is at the end of the screening zone 7, i.e. on the lower portion of the pulsation wing, formed in such a way that the pressure difference between its outside 22 (facing the screening means 5) and its inside 23 (facing the rotor 6) at operation substantially decreases gradually in the direction to the reject chamber 12. This is achieved in that the area of the pulsation wing 9 substantially decreases gradually in the direction to its lower edge 24, in that the extension of the pulsation wing 9 in tangential direction substantially decreases gradually in the lower portion of the pulsation wing 9 in the direction to the lower edge 24, and where this decrease in extension is made from the rear edge 21 of the pulsation wing 9. The pulsation wing 9, however, should along its entire length have a certain extension in tangential direction in order to ensure that a certain suction pulse and energy input is obtained. The leading edge of the pulsation wing 9 should be at the same distance from the screening means 5 along the entire length of the pulsation wing. At the embodiment according to FIG. 1 the pulsation wing 9 is cut off at an angle of 45 degrees from its rear edge 21 in the direction to the comer between the leading edge 20 and lower edge 24, but not all the way to the comer. The reason for this is to ensure that a certain suction pulse is obtained also at the lowermost portion of the pulsation wing. At the embodiment shown, thus, the extension in tangential direction of the pulsation wing 9 does not decrease at the lowermost portion of the pulsation wing 9 and, thus, no additional reduction of the pressure difference between the outside 22 and inside 23 is obtained other than the one obtained due to edge effects. The pressure difference between the outside 22 and inside 23 of the pulsation wing 9, however, is so small that no great flow of pulp from the reject chamber 12 to the screening zone 7 is obtained.

At the embodiment according to FIG. 3 the pulsation wing 9 is cut off rounded. This embodiment, compared to the embodiment shown in FIG. 1, brings about a greater reduction of the area of the pulsation wing 9 in its lower portion and, thus, a more favourable decrease of the pressure difference. The difference in reduced area is shown by the dashed area B in FIG. 4.

The lower portion of the pulsation wing 9, i.e. the portion where the extension in tangential direction substantially decreases gradually, extends starting from the lower edge 24 of the pulsation wing in axial direction corresponding to 0.5-2 times, but suitably to 1-1.5 times the greatest extension of the pulsation wing 9 in tangential direction. The pulsation wing 9, in order to generate a suction pulse along the entire length of the screening means 5, should have a smallest extension in tangential direction of at least ⅕, but suitably at least ¼ of the greatest extension of the pulsation wing 9 in tangential direction.

A pulsation wing can also be formed so that its extension in tangential direction at the lowermost portion of the pulsation wing approaches zero. Thereby energy input to the pulp, but almost no suction pulse, is obtained. There is, however, the risk that the lowermost bit of the screening means can get clogged, with resulting deteriorated capacity of the screening device.

The pressure difference between the inside and outside of the pulsation wing at the end of the screening zone can also be decreased, for example, in that the angle of incidence α of the pulsation wing to the screening means is reduced in the lower portion of the screening zone in the direction to the lower edge of the pulsation wing. This can be achieved, for example, by a turned wing. The pressure difference, of course, can also be reduced by a combintion of decreasing angle of incidence and reducing area in the direction to the lower edge of the pulsation wing.

At least one of the pulsation wings in the screening device shall be formed according to the invention, but in order to obtain a flow as small as possible from the reject chamber to the screening zone, all pulsation wings preferably should be formed so that the pressure difference between the inside and outside of the pulsation wing decreases at the lower portion of the screening zone.

This invention, of course, is not restricted to the embodiments shown, but can be varied within the scope of the claims with reference to description and drawings.

1. A screening device for fiber suspensions, comprising a housing (1) with a screening means (5), and a rotary rotor (6) provided with pulsation wings (9) located at the screening means (5), whereby a screening zone (7) is formed along the screening means (5), inlet (2) for the fiber suspension, inject, a reject chamber (12) with a reject outlet (4) for reject, and an accept chamber (11) with outlet (3) for screened fiber suspension, where every pulsation wing (9) has a lower edge (24) toward the reject chamber (12), an outside (22) and an inside (23), where the outside (22) faces the screening means (5), and a leading edge (20) and a rear edge (21), charaeterized in that at least one pulsation wing (9) is formed so that the pressure difference between the outside (22) and inside (23) of the pulsation wing (9) decreases at the lower portion of the pulsation wing (9) in the direction to the lower edge (24).

2. A screening device as defined in claim 1, characterized in that all pulsation wings are formed so that the pressure difference between the outside (22) and inside (23) of every pulsation wing (9) decreases at the lower portion of the pulsation wing (9) in the direction to the lower edge (24).

3. A screening device as defined in claim 1 or 2, characterized in that the lower portion of the pulsation wing (9) extends, starting from the lower edge (24) of the pulsation wing, in axial direction corresponding to 0.5-2 times the greatest extension of the pulsation wing (9) in tangential direction.

4. A screening device as defined in claim 1 or 2, characterized in that the lower portion of the pulsation wing (9) extends, starting from the lower edge (24) of the pulsation wing (9), in axial direction corresponding to 1-1.5 times the greatest extension of the pulsation wing (9) in tangential direction.

5. A screening device as defined in any one of the preceding claims, characterized in that the extension of the pulsation wing (9) in tangential direction decreases gradually in the lower portion of the pulsation wing (9) in the direction of the lower edge (24), and where this decrease in extension is made from the rear edge (21) of the pulsation wing (9).

6. A screening device as defined in claim 5, characterized in that the smallest extension of the pulsation wing (9) in tangential direction is at least ⅕ of the greatest extension of the pulsation wing (9) in tangential direction.

7. A screening device as defined in claim 5, characterized in that the smallest extension of the pulsation wing (9) in tangential direction is at least ¼ of the greatest extension of the pulsation wing (9) in tangential direction.

8. A rotor (6) for use in a screening device according to any one of the claims 1 to 7.
